(19) United States
(12) Patent Application Publication
(10) Pub. No.: US 2026/0205908 A1
(43) Pub. Date: Jul. 16, 2026

(54) METHODS AND APPARATUSES FOR COMMON CONFIGURATION IN NON-TERRESTRIAL NETWORK

(71) Applicant: Lenovo (Beijing) Limited, Beijing (CN)

(72) Inventors: Min Xu, Beijing (CN); Lianhai Wu, Beijing (CN); Ran Yue, Beijing (CN); Jing Han, Beijing (CN); Jie Hu, Beijing (CN)

(73) Assignee: Lenovo (Beijing) Limited, Beijing (CN)

(21) Appl. No.: 19/134,674

(22) PCT Filed: Jan. 20, 2023
(86) PCT No.: PCT/CN2023/073418

§ 371 Date: May 30, 2025

(51) Int. Cl. H04W 36/08

(52) U.S. Cl. CPC H04W 36/083

(57) ABSTRACT

Embodiments of the present application are related to methods and apparatuses for common configuration in non-terrestrial network (NTN). An embodiment of the present application provides a user equipment including: a transceiver and a processor coupled to the transceiver, wherein the processor is configured to: receive, with the transceiver and from a base station (BS), receive, with the transceiver and from a BS, a configuration associated with mobility management of a non-terrestrial network (NTN) via multicast signaling or broadcast signaling; and apply the configuration associated with the mobility management for the UE to switch from a source cell to a target cell.

### TECHNICAL FIELD

The present disclosure generally relates to methods and apparatus for common configuration in non-terrestrial network (NTN).

### BACKGROUND OF THE INVENTION

NTN refers to a network, or segment of networks using radio frequency (RF) resources on board a satellite. The satellite in NTN can be a Geostationary Earth Orbiting (GEO) satellite with fixed location to the Earth, or a Low Earth Orbiting (LEO) satellite orbiting around the Earth. 3rd Generation Partnership Project (3GPP) Rel-17 specifications have provided basic support of NTN features and in Rel-18 further enhancements including mobility are to be studied.

In Rel-17 NTN the configuration for mobility management (i.e., handover) follows legacy mechanism of per user equipment (UE) configuration, including the original configurations for terrestrial network (TN) and/or the NTN-specific configurations (e.g., location/time-based metric and target cell ephemeris data). Due to the large coverage of NTN cells and consequent large UE number, the signaling overhead for mobility management in an NTN cell is much more than that in a TN cell before and after handover.

### SUMMARY

Thus, it is proposed to transmit information common to multiple UEs in a NTN cell via common signaling by broadcast or multicast. To achieve said objective, the content(s) of the information and how to apply the content(s) should be determined.

Some embodiments of the present disclosure provide a UE including: a transceiver and a processor coupled to the transceiver, wherein the processor is configured to: receive, with the transceiver and from a BS, a configuration associated with mobility management of a NTN via multicast signaling or broadcast signaling; and apply the configuration associated with the mobility management for the UE to switch from a source cell to a target cell.

In some embodiments, the multicast signaling or the broadcast signaling is received via dedicated signaling radio bearer (SRB) including multicast or broadcast service (MBS) radio bearer (MRB) or dedicated control channel including multicast control channel (MCCH) in MBS.

In some embodiments, the mobility management includes at least one of: a handover (HO) or condition handover (CHO) to the target cell; random access (RA) initiation to the target cell; or connection reestablishment to the target cell.

In some embodiments, the configuration associated with the mobility management includes at least one of the following: a mobility scenario indication indicating an intra-node mobility or an inter-node mobility; a timing advance (TA) or timing alignment indication indicating whether TA update is needed for the mobility management; a cell identity change indication indicating whether a target cell identity matches a source cell identity or whether a target cell configuration matches a source cell configuration; or at least one mobility threshold associated with at least one criteria for applying the configuration associated with the mobility management.

In some embodiments, the configuration is associated with at least one of: the source cell; the target cell; the at least one mobility threshold; at least one measurement identity or measurement object; or at least one UE group identity.

In some embodiments, in the case that the configuration is associated with the source cell, the processor is configured to apply the configuration.

In some embodiments, in the case that the configuration is associated with the at least one mobility threshold, the processor is configured to: determine whether to apply the configuration based on fulfillment of the at least one criteria for applying the configuration; or determine whether to execute a HO command based on the fulfillment of the at least one criteria for applying the configuration; or determine whether to execute a CHO when condition(s) for the CHO are fulfilled based on the fulfillment of the at least one criteria for applying the configuration.

In some embodiments, the at least one mobility threshold includes at least one of: a received signal strength or quality threshold for the source cell; a received signal strength or quality threshold for the target cell; a distance threshold relative to a source node; a distance threshold relative to a target node; a propagation delay or round trip time (RTT) or TA threshold associated with the source cell; a propagation delay or RTT or TA threshold associated with the target cell; a differential propagation delay or differential RTT or differential TA threshold between the source cell and the target cell; an elevation angle threshold of the source node; or an elevation angle threshold of the target node;

In some embodiments, the processor is configured to apply the configuration in the case that the configuration is associated with the at least one measurement identity or measurement object, and the UE is configured with the at least one measurement identity or measurement object.

In some embodiments, the processor is configured to apply the configuration in the case that the configuration is associated with the at least one user group and the UE is configured to be associated with the at least one user group or fulfils a condition to be associated with the at least one user group.

In some embodiments, the processor is configured to apply the configuration in the case that the configuration is associated with the target cell, and the UE receives a HO command to the target cell or a condition for CHO to the target cell is met.

In some embodiments, the mobility scenario indication indicates whether the HO or the CHO is intra-node or inter-node; the TA or timing alignment indication indicates whether to update or calculate TA in the target cell; the cell identity change indication indicates whether a target cell identity is the same as the source cell identity; and the at least one criteria is for assisting determination of whether to apply other content(s) of the configuration or to perform the HO or the CHO.

In some embodiments, the mobility scenario indication is an explicit parameter or a target node identity; and the cell identity change indication is an explicit parameter or a target cell identity.

In some embodiments, the configuration includes the mobility scenario indication, and when the UE performs connection reestablishment to the target cell, the processor is configured to: calculate TA for the target cell in the case that the mobility scenario indication indicates that the HO or the CHO is inter-node; or use a current TA of the source cell in the target cell in the case that the mobility scenario indication indicates that the HO or the CHO is intra-node.

In some embodiments, the configuration includes the TA update or calculation indication, and when the UE performs connection reestablishment to the target cell, the processor is configured to: calculate TA for the target cell in the case that the TA or timing alignment indication indicates to update or calculate TA; or use a current TA of the source cell in the target cell in the case that the TA or timing alignment indication indicates not to update TA.

In some embodiments, the configuration includes the cell identity change indication, and after the UE performs the HO or the CHO to the target cell, the processor is configured to: omit RA and initiate connection reestablishment in the target cell by using uplink resources configured in the source cell in the case that the cell identity change indication indicates that the target cell identity is the same as the source cell identity; or initiate RA or connection reestablishment in the target cell in the case that the cell identity change indication indicates that the target cell identity is different from the source cell identity.

In some embodiments, in the case that the cell identity change indication indicates that the target cell identity is different from the source cell identity, the RA is initiated at a configured time by using a configured preamble set or by using configured uplink resources, and wherein the configured time, the configured preamble set, or configured uplink resources are included in the configuration or received via system information, multicast signaling, or signaling dedicated for the UE.

In some embodiments, the configuration includes differential parameter(s) between the target cell and the source cell, and when the UE performs HO or CHO to the target cell, the processor is configured to derive corresponding parameter(s) of the target cell.

In some embodiments, the differential parameter(s) are associated with at least one of ephemeris, common TA, epoch time of ephemeris, or epoch time of common TA.

In some embodiments, the HO or the CHO is performed in the case that the configuration is received.

In some embodiments, in the case that part of the configuration is received, the HO or the CHO is performed in the case that at least one of the following is fulfilled: the mobility scenario indication, source cell ephemeris, and common TA of the source cell are received, wherein the mobility scenario indication indicates that the HO or the CHO is intra-node; the mobility scenario indication, target cell ephemeris, and common TA of the target cell are received, wherein the mobility scenario indication indicates that the HO or the CHO is inter-node; the cell identity change indication and configured uplink resource for connection reestablishment are received, wherein the cell identity change indication indicates that the target cell identity is the same as the source cell identity; the cell identity change indication, and at least one of a configured time for RA initiation or a configured preamble set are received, wherein the cell identity change indication indicates that the target cell identity is different from the source cell identity; the cell identity change indication and configured uplink resource(s) for RA or connection reestablishment are received, wherein the cell identity change indication indicates that the target cell identity is different from the source cell identity.

In some embodiments, the processor is configured to receive, with the transceiver, at least one of the following via the configuration, system information, multicast signaling, or signaling dedicated for the UE: the source cell ephemeris, the common TA of the source cell, the common TA of the target cell; the configured uplink resource for connection reestablishment, the configured time for RA initiation, the configured preamble set, or the configured uplink resource(s) for RA or connection reestablishment.

In some embodiments, the configuration includes at least one validity duration associated with at least one other content within the configuration, the processor is configured to: start at least one timer for the at least one other content; and re-acquire the configuration or the at least one other content within the configuration before or after expiration of the at least one timer.

In some embodiments, the configuration is received periodically.

Some embodiments of the present disclosure provide a BS including: a transceiver and a processor coupled to the transceiver, wherein the processor is configured to: generate a configuration associated with mobility management of a NTN for a UE to switch from a source cell to a target cell; and broadcast or multicast, with the transceiver, the configuration associated with the mobility management.

In some embodiments, the multicast signaling or the broadcast signaling is transmitted via dedicated SRB including MRB or dedicated control channel including MCCH in MBS.

In some embodiments, the mobility management includes at least one of: a HO or CHO to the target cell; RA initiation to the target cell; or connection reestablishment to the target cell.

In some embodiments, the configuration associated with the mobility management includes at least one of following: a mobility scenario indication indicating an intra-node mobility or an inter-node mobility; a TA or timing alignment indication indicating whether TA update is needed for the mobility management; a cell identity change indication indicating whether a target cell identity matches a source cell identity or whether a target cell configuration matches a source cell configuration; or at least one mobility threshold associated with at least one criteria for applying the configuration for the mobility management.

In some embodiments, the configuration is associated with at least one of: the source cell; the target cell; the at least one mobility threshold; at least one measurement identity or measurement object; or at least one UE group identity.

In some embodiments, the at least one mobility threshold includes at least one of: a received signal strength or quality threshold for the source cell; a received signal strength or quality threshold for the target cell; a distance threshold relative to a source node; a distance threshold relative to a target node; a propagation delay or RTT or TA threshold associated with the source cell; a propagation delay or RTT or TA threshold associated with the target cell; a differential propagation delay or differential RTT or differential TA threshold between the source cell and the target cell; an elevation angle threshold of the source node; or an elevation angle threshold of the target node.

In some embodiments, the mobility scenario indication indicates whether the HO or the CHO is intra-node or inter-node; the TA or timing alignment indication indicates whether to update or calculate TA in the target cell; the cell identity change indication indicates whether the target cell identity is the same as the source cell identity; and the at least one criteria is for assisting determination of whether to apply other contents of the configuration or to perform the HO or the CHO.

In some embodiments, the mobility scenario indication is an explicit parameter or a target node identity; and the cell identity change indication is an explicit parameter or a target node identity.

In some embodiments, the configuration is associated with the target cell and includes differential parameter(s) between the target cell and the source cell.

In some embodiments, the differential parameter(s) are associated with at least one of ephemeris, common TA, epoch time of ephemeris, or epoch time of common TA.

In some embodiments, the processor is configured to transmit, with the transceiver, at least one of the following via the configuration, system information, multicast signaling, or signaling dedicated for the UE: source cell ephemeris, common TA of the source cell, common TA of the target cell; configured uplink resource for connection reestablishment, a configured time for RA initiation, a configured preamble set, or a configured uplink resource(s) for RA or connection reestablishment.

In some embodiments, the configuration includes at least one validity duration associated with at least one other content within the configuration, the processor is configured to: start at least one timer for the at least one other content; and re-multicast or re-broadcast the at least one other content within the configuration before or after expiration of the at least one timer.

In some embodiments, the configuration is transmitted periodically.

Some embodiments of the present disclosure provide a method performed by a UE. The method includes: receiving a configuration associated with mobility management of a NTN via multicast signaling or broadcast signaling; and applying the configuration associated with the mobility management for the UE to switch from a source cell to a target cell.

Some embodiments of the present disclosure provide a method performed by a BS. The method includes: generating a configuration associated with mobility management of a NTN for a UE to switch from a source cell to a target cell; and broadcast or multicast, with the transceiver, the configuration associated with the mobility management.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present disclosure.

FIG. 2 illustrates a flowchart of an exemplary method for common configuration in NTN according to some embodiments of the present disclosure.

FIG. 3 illustrates a simplified block diagram of an exemplary apparatus according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as 3GPP long term evolution (LTE), LTE advanced, 5G new radio (NR), 5G-Advanced, 6G, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

The present disclosure provides various solutions to implement procedures in UL positioning, e.g., procedures for SRS activation or deactivation within a validity area, TA update within a validity area, or update of SRS configuration and the associated validity area.

FIG. 1 is a schematic diagram illustrating an exemplary NTN system 100 in NTN according to some embodiments of the present disclosure.

As shown in FIG. 1, the NTN system 100 in NTN includes: at least one radio access network (RAN) node (e.g., Node 1) and at least one UE (e.g., UE 1, UE 2, UE 3, or UE 4). Although one RAN node and four UEs are depicted in FIG. 1 for illustrative purpose, it is contemplated that any number of nodes and UEs may be included in the NTN system 100 according to various embodiments of the present disclosure.

The NTN system 100 is compatible with any type of network that is capable of sending and receiving wireless communication signals. For example, the NTN system 100 is compatible with a wireless communication network, a cellular telephone network, a time division multiple access (TDMA) based network, a code division multiple access (CDMA) based network, an orthogonal frequency division multiple access (OFDMA) based network, an LTE network, a 3GPP-based network, a 3GPP 5G network, a satellite communications network, a high-altitude platform network, and/or other communications networks.

The Node 1 may be a satellite, an unmanned aerial vehicle, a device on a balloon, a high altitude platform (HAP), etc.; it may be configured with antenna unit(s) of a base station (BS) or may be an entire BS.

A BS in the present disclosure may be referred to as an access point, an access terminal, a base, a macro cell, a radio access network (RAN) node, a next generation (NG) RAN node, a node-B, an enhanced or evolved node B (eNB), a generalized node B (gNB), a home node-B, a relay node, or a device, or described using other terminology used in the art.

In some embodiments, when a UE (e.g., UE 1, UE 2, UE 3, or UE 4) is in a coverage area of a node (e.g., Node 1), the UE may communicate with the node, for example, via LTE or NR Uu interface.

According to some embodiments of the present application, the UEs (e.g., UE 1, UE 2, UE 3, or UE 4) may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE. In an embodiment of the present application, the UE 102 may be an LPHAP UE.

According to some other embodiments of the present application, the UEs may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UEs may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UEs may include wearable devices, such as smart watches, fitness bands, optical head-mounted displays, or the like.

Moreover, a UE (e.g., UE 1, UE 2, UE 3, or UE 4) may be referred to as a subscriber unit, a mobile, a mobile station, a user, a terminal, a mobile terminal, a wireless terminal, a fixed terminal, a subscriber station, a user terminal, or a device, or described using other terminology used in the art.

In the NTN system 100, the NTN cells (e.g., Cell 1, Cell 2, or Cell 3) have large coverages and accordingly, may have large number of UEs. The signalling overhead for mobility management in an NTN cell may be much more than that in a TN cell before or after HO or CHO. It needs to take measures to reduce the signaling overhead in NTN.

As the NTN cells have large coverages, the surrounding environments and the configurations for the UEs at a similar location or the same location may be similar or the same in certain aspect (e.g., HO or CHO), the present disclosure provides various methods about providing common configurations associated with mobility management via multicast signaling or broadcast signaling to all the UEs in a source cell.

The UE may apply the common configuration for mobility management to: all the UEs in a source cell, or one or more UEs associated with a target cell, or one or more UEs within a source cell that are associated with a user group or fulfil a condition to be associated with a user group, or one or more UEs associated with a measurement identity or a measurement object, or one or more UEs associated with one UE group identity, or one or more UEs associated with at least one threshold that is associated with at least one criteria.

For example, referring back to in FIG. 1 for example, the candidate target cell for UE 1 and UE 2 is Cell 2, the candidate target cell for UE 3 and UE 4 is Cell 3. The configuration of Cell 2 and the configuration of Cell 3 may be transmitted to multiple UEs within Cell 1 (including UE 1, UE 2, UE 3, and UE 4) via multicast signaling or broadcast signaling. The BS does not transmit the configuration of Cell 2 and the configuration of Cell 3 to each of these UEs in dedicated signaling. Therefore, the signaling overhead is reduced. When UE 1 or UE 2 performs mobility operations to the target Cell 2, the UE 1 or UE 2 may apply the configuration of Cell 2 received via multicast signaling or broadcast signaling. When UE 3 or UE 4 performs mobility operations to the target Cell 3, the UE 3 or UE 4 may apply the configuration of Cell 3 received via multicast signaling or broadcast signaling.

According to some embodiments of the present disclosure, the mobility management includes at least one of a mobility operation, e.g.: a HO or a CHO, RA initiation to the target cell, or connection reestablishment to the target cell. One advantage is that it brings the possibility of reducing signaling overhead in NTN cells e.g., in the NTN system 100 in NTN. In some embodiments, some mobility operations for the mobility management may be even omitted to further reduce the signaling overhead in the NTN cells.

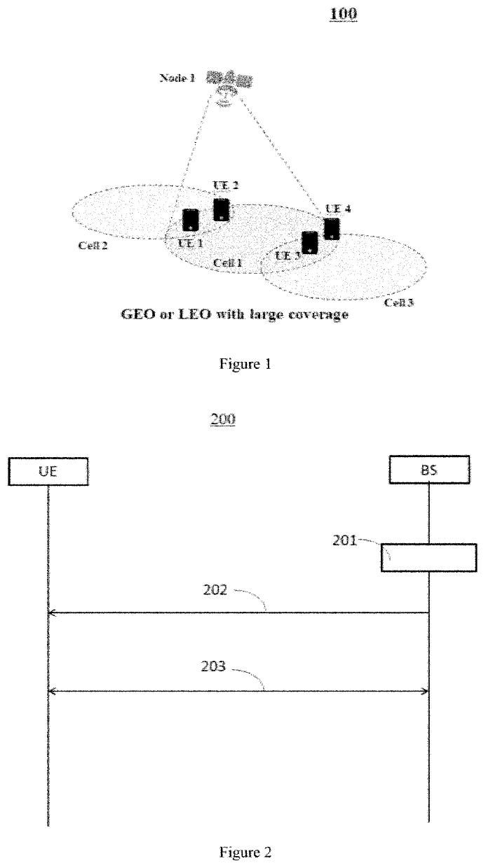

FIG. 2 illustrates a flowchart of an exemplary method 200 for mobility management in NTN according to some embodiments of the present disclosure. The method 200 illustrated in FIG. 2 may be performed by at least two entities, e.g., a UE (e.g., UE 1, UE 2, UE 3, or UE 4) and a BS (not explicitly in FIG. 1). Although the method is illustrated in a system level, persons skilled in the art can understand that the method implemented in the two entities can be separately implemented and incorporated in other apparatus with the like functions. It is also contemplated that the method 200 may include additional steps not shown. Referring back to FIG. 1 for example, the BS may be Node 1 if Node 1 is an entire BS, or may include Node 1 if Node 1 is only the antenna unit(s) of the BS.

In step 201, the BS generates a common configuration associated with mobility management of a NTN (e.g., the NTN system 100 illustrated in FIG. 1) for the UE to switch from a source cell to a target cell.

In some embodiments, the common configuration includes at least one of the following contents:
a mobility scenario indication indicating an intra-node mobility or an inter-node mobility;
a TA or timing alignment indication indicating whether TA update is needed with the mobility management;
a cell identity change indication indicating whether a target cell identity matches a source cell identity or whether a target cell configuration matches a source cell configuration; or
at least one mobility threshold or at least one mobility range associated with at least one criteria for applying the common configuration for the mobility management.

In some embodiments, the at least one mobility threshold includes at least one of:
a received signal strength or quality threshold for the source cell;
a received signal strength or quality threshold for the target cell;
a distance threshold relative to a source node;
a distance threshold relative to a target node;
an RTT or TA threshold associated with the source cell;
a propagation delay or RTT or TA threshold associated with the target cell;
a differential propagation delay or differential RTT or differential TA threshold between the source cell and the target cell;
an elevation angle threshold of the source node; or
an elevation angle threshold of the target node.

In some embodiments, the at least one mobility range includes at least one of:
a received signal strength or quality range for a source cell;
a received signal strength or quality range for a target cell;
a location range relative to the source node;
a location range relative to the target node;
a propagation delay or RTT or TA range associated with the target cell;
a propagation delay or RTT or TA range associated with the target cell;
a differential propagation delay or differential RTT or differential TA range between the source cell and the target cell;
an elevation angle range of the source node;
an elevation angle range of the target node.

In some embodiments, the mobility management includes at least one mobility operation of the following mobility operations:
a HO or a CHO to the target cell;
RA initiation to the target cell; or
connection reestablishment to the target cell.

In some embodiments, the common configuration is associated with at least one of:
a source cell;
a target cell;
the at least one mobility threshold or the at least one mobility range;
at least one measurement identity or measurement object; or
at least one UE group identity.

In step 202, the BS broadcasts or multicasts the common configuration associated with the mobility management of the NTN; the UE may receive the common configuration of the NTN via multicast signaling or broadcast signaling.

In some embodiments, the BS may generate and transmit the common configuration periodically.

In some embodiments, the UE may receive the multicast signaling or the broadcast signaling via dedicated SRB including MRB or dedicated control channel including MCCH in MBS.

In some embodiments, the common configuration includes a validity duration; the common configuration is valid within the validity duration. The UE may start a timer with a length of the validity duration upon reception of the common configuration, and may re-acquire the common configuration before or after the time expires.

In some embodiments, the common configuration includes at least one validity duration associated with at least one content within the common configuration; a corresponding individual content within the common configuration is valid within a corresponding validity duration. In some embodiments, the UE may start a corresponding timer with a length of a corresponding validity duration associated with a corresponding individual content upon reception of the corresponding individual content within the common configuration; the UE may re-acquire an individual content within the common configuration before or after the corresponding timer expires. In some embodiments, the BS may start a corresponding timer with a length of a corresponding validity duration associated with a corresponding individual content upon transmission of the corresponding individual content within the common configuration; the BS may re-broadcast or re-multicast an individual content within the common configuration before or after the corresponding timer expires.

According to some embodiments of the present disclosure, in step 203, the UE applies the common configuration associated with the mobility management to switch from a source cell to a target cell.

In some embodiments, the common configuration is associated with a source cell, the UE may apply the common configuration to mobility operations. In some embodiments, each of the UEs within the source cell may apply the common configuration associated with the source cell.

In some embodiments, the common configuration is associated with the at least one mobility threshold or the at least one mobility range that is included in the common configuration and associated with the at least one criteria, the UE may determine whether to apply the common configuration for mobility management based on fulfillment of the at least one criteria for applying the common configuration. In some embodiments, each of the UEs that receives the common configuration may determine whether to apply the common configuration for mobility management based on fulfillment of the at least one criteria for applying the common configuration.

In some embodiments, the common configuration is associated with the at least one mobility threshold or the at least one mobility range that is included in the common configuration and associated with the at least one criteria, the UE may determine whether to execute a HO command based on fulfillment of the at least one criteria for applying the common configuration. In some embodiments, each of the UEs that receives the common configuration may determine whether to execute a HO command based on fulfillment of the at least one criteria for applying the common configuration.

In some embodiments, the common configuration is associated with the at least one mobility threshold or the at least one mobility range that is included in the common configuration and associated with the at least one criteria, the UE may determine whether to execute a CHO when condition(s) for the CHO are fulfilled based on fulfillment of the at least one criteria for applying the common configuration. In some embodiments, each of the UEs that receives the common configuration may determine whether to execute a CHO when condition(s) for the CHO are fulfilled based on fulfillment of the at least one criteria for applying the common configuration

In some embodiments, the common configuration is associated with the at least one measurement identity or measurement object; in the case that the UE is configured with the at least one measurement identity or measurement object, the UE may apply the common configuration. In some embodiments, each of the UEs that receives the common configuration and is configured with the at least one measurement identity or measurement object may apply the common configuration.

In some embodiments, the common configuration is associated with the at least one user group; in the case that the UE is configured to be associated with the at least one user group or fulfils a condition to be associated with the at least one user group, the UE may apply the common configuration. In some embodiments, each of the UEs that receives the common configuration and is associated with the at least one user group or fulfils the condition to be associated with the at least one user group may apply the common configuration.

In some embodiments, the common configuration is associated with a target cell; in the case that the UE receives a HO command to the target cell or condition(s) for CHO to the target cell are met; the UE may apply the common configuration. In some embodiments, for each of the UEs receiving the common configuration associated with a target cell, if the UE receives a HO command to the target cell or the condition(s) for a CHO to the target cell are fulfilled, the UE may apply the common configuration.

In some cases the common configuration is associated with a target cell; the common configuration includes a mobility scenario indication indicating whether the HO or the CHO is intra-node or inter-node. The UE may apply the common configuration according to at least the mobility scenario indication if a HO command to the target cell is received or the condition(s) for the CHO to the target cell are fulfilled. In some embodiments, the mobility scenario indication is an explicit parameter indicating whether the HO or CHO is intra-node or inter-node. In some embodiments, the mobility scenario indication is a target node identity; if the target node identity is the same as the source node identity, the UE may determine that the HO or the CHO is intra-node; if the target node identity is different from the source code identity, the UE may determine that the HO or the CHO is inter-node. In some embodiments, if the mobility scenario indication indicates that the HO or the CHO is intra-node, the UE may use a current TA of the source cell in the target cell. In some embodiments, if the mobility scenario indication indicates that the HO or the CHO is inter-node, the UE may calculate TA for the target cell.

In some cases, the common configuration is associated with a target cell, and the common configuration includes a TA or timing alignment indication indicating whether to update or calculate TA in the target cell. The UE may apply the common configuration according to at least the TA or timing alignment indication if a HO command to the target cell is received or the condition(s) for the CHO to the target cell are fulfilled. In some embodiments, if the TA or timing alignment indication indicates not to update or calculate TA, the UE may use a current TA of the source cell in the target cell. In some embodiments, if the TA or timing alignment indication indicates to update or calculate TA, the UE may calculate TA for the target cell.

In some cases, the common configuration is associated with a target cell, and the common configuration includes a cell identity change indication indicating whether a target cell identity of the target cell is the same as a source cell identity of the source cell. The UE may apply the common configuration according to at least the cell identity change indication if a HO command to the target cell is received or the condition(s) for the CHO to the target cell are fulfilled. In some embodiments, the cell identity change indication is an explicit parameter indicating whether the target cell identity is the same as the source cell identity. In some embodiments, the cell identity change indication is a target cell identity; if the target cell identity is the same as the source cell identity, the UE may determine that the target cell inherits the cell identity and configurations of the source cell after it replaces the source cell coverage; if the target cell identity is different from the source cell identity, the UE may determine that the target cell does not inherit the cell identity and configurations of the source cell after it replaces the source cell coverage. In some embodiments, if the target cell identity is the same as the same as the source cell identity, the UE may omit RA and initiate connection reestablishment in the target cell by using uplink resources configured in the source cell. In some embodiments, if the cell identity change indication indicates that the target cell identity is different from the source cell identity, the UE may initiate an RA or connection reestablishment in the target cell.

In some embodiments, the cell identity change indication indicates that the target cell identity is different from the source cell identity; if the RA is a contention based random access (CBRA), the UE may initiate the RA at a configured time and/or by using a configured preamble set. In some embodiments, the configured time or the configured preamble set may be included in the common configuration, or be received via system information, multicast signaling, or signaling dedicated for the UE.

In some embodiments, the cell identity change indication indicates that the target cell identity is different from the source cell identity; if the RA is a contention free random access (CFRA), the UE may initiate the RA by using configured uplink resources. In some embodiments, the configured uplink resources is included in the common configuration, or be received via system information, multicast signaling, or signaling dedicated for the UE.

In some cases, the common configuration is associated with a target cell, and the common configuration includes at least one mobility threshold or the at least one mobility range associated with at least one criteria. In some embodiments, the at least one criteria is for assisting the UE to determine whether to apply the other content(s) of the common configuration when the UE receives a HO command to the target cell or the condition(s) for a CHO to the target cell are fulfilled; when the at least one criteria is fulfilled, the UE may apply the other content(s) of the common configuration after the UE receives a HO command to the target cell or the condition(s) for a CHO to the target cell are fulfilled. In some embodiments, the at least one criteria is for assisting the UE to determine whether to perform the HO after reception of a HO command to the target cell or whether to perform the CHO to the target cell if the execution condition(s) for the CHO are fulfilled; when the at least one criteria is fulfilled, the UE may perform HO or CHO to the target cell.

In some embodiments, the common configuration is associated with a target cell, and the common configuration includes differential parameter(s) between the source cell and the target cell; when the UE receives a HO command to the target cell or condition(s) for performing a CHO to the target cell are fulfilled, the UE may derive parameter(s) of the target cell based on the differential parameter(s) and parameter(s) of the source cell, wherein the derived parameter(s) may be used for the HO or CHO to the target cell, or RA to the target cell, or connection reestablishment to the target cell. In some embodiments, the differential parameter(s) are associated with at least one of ephemeris, common TA, epoch time of ephemeris, or epoch time of common TA between the target cell and the source cell.

In some embodiments, the common configuration is associated with at least a target cell. When the UE receives a HO command to the target cell or the condition(s) for a CHO to the target cell are fulfilled, the UE may perform the HO or CHO and subsequent mobility operations after reception of the whole configuration. In other words, the UE may postpone the execution of the HO or CHO until the whole configuration is received.

In some embodiments, the common configuration is associated with at least a target cell. When the UE receives a HO command to the target cell or the condition(s) for a CHO to the target cell are fulfilled, the UE may perform the HO or CHO and subsequent mobility operations if only an essential part of the common configuration and some other necessary information are received.

In some embodiments, the essential part of the common configuration is the mobility scenario indication; the some other necessary information is the source cell ephemeris and common TA of the source cell, wherein the mobility scenario indication indicates that the HO or the CHO is intra-node. In some embodiments, the source cell ephemeris or the common TA of the source cell may be received via system information, multicast signaling, or signaling dedicated for the UE.

In some embodiments, the essential part of the common configuration is the mobility scenario indication; the some other necessary information is the target cell ephemeris and common TA of the target cell, wherein the mobility scenario indication indicates that the HO or the CHO is inter-node. In some embodiments, the target cell ephemeris or the common TA of the target cell may be received via system information, multicast signaling, or signaling dedicated for the UE.

In some embodiments, the essential part of the common configuration is the cell identity change indication; the some other necessary information is the configured uplink resource for connection reestablishment, wherein the cell identity change indication indicates that the target cell identity is the same as the source cell identity (i.e., the target cell inherits the cell identity and configurations of the source cell after it replaces the source cell coverage). In some embodiments, the configured uplink resource for connection reestablishment may be received via system information, multicast signaling, or signaling dedicated for the UE.

In some embodiments, the essential part of the common configuration is the cell identity change indication; the some other necessary information is a configured time for CBRA initiation or a configured preamble set for CBRA, wherein the cell identity change indication indicates that the target cell identity is different from the source cell identity, and the RA is a CBRA. In some embodiments, the configured time for CBRA initiation or the configured preamble set for CBRA may be received via system information, multicast signaling, or signaling dedicated for the UE.

In some embodiments, the essential part of the common configuration is the cell identity change indication; the some other necessary information is configured uplink resource(s) for CFRA or connection reestablishment after the CFRA, wherein the cell identity change indication indicates that the target cell identity is different from the source cell identity, and the RA is a CFRA. In some embodiments, the configured uplink resource(s) for CFRA or connection reestablishment may be received via system information, multicast signaling, or signaling dedicated for the UE.

In some embodiments, a common configuration may include one or more sub common configurations; each sub common configuration is associated with at least one of: a source cell; a target cell; at least one mobility threshold; at least one measurement identity or measurement object; or at least one UE group identity.

In some embodiments, a common configuration may be associated with at with one or more target cells. In some embodiments, the one or more target cells may include one or more specified neighboring cells surrounding a current serving cell (or a source cell). When the UE performs mobility operations to a target cell of the one or more target cells, it may apply the common configuration.

In some embodiments, a common configuration includes one or more sub common configurations, and at least one sub common configuration of the one or more sub common configuration is associated with an individual target cell. When the UE performs mobility operations to a target cell associated with a sub common configuration of the common configuration, it may apply the associated sub common configuration.

For example, referring back to FIG. 1 as an example, the common configuration includes at least two sub common configurations, one sub common configuration is associated with Cell 2, and one sub common configuration is associated with Cell 3. If UE 1 performs mobility operations to Cell 2, it may apply the sub common configuration associated with Cell 2. If UE 4 performs mobility operations to Cell 3, it may apply the sub common configuration associate with Cell 3. Furthermore, if the common configuration includes a sub common configuration associated with the source cell Cell 1, each of the UEs (e.g., UE 1, UE 2, UE 3, or UE 4) within Cell 1 may apply the sub common configuration associated with Cell 1.

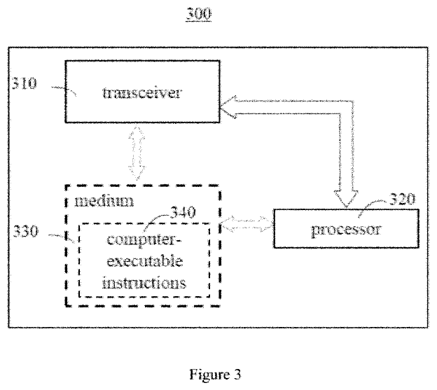

FIG. 3 illustrates a simplified block diagram of an exemplary apparatus 300 according to some embodiments of the present disclosure.

In some embodiments, the apparatus 300 may be or include at least part of a UE (e.g., UE 1, UE 2, UE 3, or UE 4) which is capable of performing any of the operations performed by a UE as described in the present disclosure.

In some embodiments, the apparatus 300 may be or include at least part of a BS (not explicitly shown in FIG. 1) which is capable of performing any of the operations performed by a BS as described in the present disclosure.

As shown in FIG. 3, the apparatus 300 may include at least a transceiver 310 and a processor 320 coupled to the transceiver 310. In some embodiments, the transceiver 310 may include a transmitter and a receiver integrated together. In some embodiments, the transceiver 310 may include a transmitter and a receiver which are separated from each other. In some embodiments, the transceiver 310 may be a wireless transceiver.

In some embodiments, the apparatus 300 may include a non-transitory computer-readable medium 330 with computer-executable instructions 340 stored thereon. The non-transitory computer-readable medium 330 may be coupled to the processor 320 and the transceiver 310, and the computer-executable instructions 340 may be configured to be executable by the processor 320. In some embodiments, the transceiver 310, the non-transitory computer-readable medium 330, and the processor 320 may be coupled to each other via one or more local buses.

Although in FIG. 3, elements such as the transceiver 310, the non-transitory computer-readable medium 330, and the processor 320 are described in the singular, the plural is contemplated unless limitation to the singular is explicitly stated. In certain embodiments of the present disclosure, the apparatus 300 may further include other components for actual usage.

In various example embodiments, the processor 320 may include, but is not limited to, at least one hardware processor, including at least one microprocessor such as a CPU, a portion of at least one hardware processor, and any other suitable dedicated processor such as those developed based on for example Field Programmable Gate Array (FPGA) and Application Specific Integrated Circuit (ASIC). Further, the processor 320 may also include at least one other circuitry or element not shown in FIG. 3.

In various example embodiments, the non-transitory computer-readable medium 330 may include at least one storage medium in various forms, such as a volatile memory and/or a non-volatile memory. The volatile memory may include, but is not limited to, for example, an RAM, a cache, and so on. The non-volatile memory may include, but is not limited to, for example, an ROM, a hard disk, a flash memory, and so on. Further, the non-transitory computer-readable medium 330 may include, but is not limited to, an electric, a magnetic, an optical, an electromagnetic, an infrared, or a semiconductor system, apparatus, or device or any combination of the above.

Further, in various example embodiments, the apparatus 300 may also include at least one other circuitry, element, and interface, for example antenna element, and the like.

According to some embodiments, the apparatus 300 is a UE. The transceiver 310 and the processor 320 may be configured to perform operations in any methods described above which are performed by a UE. For example, the processor 320 may be configured to: receive, with the transceiver 310 and from a BS, a common configuration associated with mobility management of a non-terrestrial network (NTN) via multicast signaling or broadcast signaling; and apply the common configuration associated with the mobility management for the UE to switch from a source cell to a target cell.

According to some embodiments, the apparatus 300 is a BS. The transceiver 310 and the processor 320 may be configured to perform operations in any methods described above which are performed by a BS. For example, the processor 320 may be configured to: generate a common configuration associated with mobility management of a NTN for a UE to switch from a source cell to a target cell; and broadcast or multicast, with the transceiver 310, the common configuration associated with the mobility management.

In various example embodiments, the circuitry, parts, elements, and interfaces in exemplary apparatus, including processor and non-transitory computer-readable medium, may be coupled together via any suitable connections including, but not limited to, buses, crossbars, wiring and/or wireless lines, in any suitable ways, for example electrically, magnetically, optically, electromagnetically, and the like.

The methods of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

The terms “includes,” “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “including,” “having,” and the like, as used herein, are defined as “comprising.” In this disclosure, relational terms such as “first,” “second,” and the like may be used solely to distinguish one entity or action from another entity or action without necessarily requiring or implying any actual such relationship or order between such entities or actions.

1. A user equipment (UE) for wireless communication, comprising:
at least one memory; and
at least one processor coupled with the at least one memory and configured to cause the UE to:
receive, from a BS, a configuration associated with mobility management of a non-terrestrial network (NTN) via broadcast signaling; and
apply the configuration associated with the mobility management to switch the UE from a source cell to a target cell.

2. The UE of claim 1, wherein the mobility management includes at least one of:
a handover (HO) or condition handover (CHO) to the target cell;
random access (RA) initiation to the target cell; or
connection reestablishment to the target cell.

3. The UE of claim 2, wherein the configuration associated with the mobility management includes at least one of:
a mobility scenario indication indicating an inter-node mobility; or
a cell identity change indication indicating whether a target cell identity matches a source cell identity or whether a target cell configuration matches a source cell configuration.

4. The UE of claim 1, wherein the configuration is associated with at least one of the source cell or the target cell.

5. The UE of claim 4, wherein, if the configuration is associated with the source cell, then the at least one processor is configured to cause the UE to apply the configuration.

6. The UE of claim 2, wherein, if the configuration is associated with at least one mobility threshold, then the at least one processor is configured to cause the UE to at least one of:
determine whether to apply the configuration based on fulfillment of at least one criteria for applying the configuration;
determine whether to execute a HO command based on the fulfillment of the at least one criteria for applying the configuration; or
determine whether to execute the CHO when one or more conditions for the CHO are fulfilled based on the fulfillment of the at least one criteria for applying the configuration.

7. The UE of claim 1, wherein the at least one processor is configured to cause the UE to apply the configuration if the configuration is associated with at least one measurement identity or measurement object, and the UE is configured with the at least one measurement identity or measurement object.

8. The UE of claim 3, wherein the configuration is associated with the target cell, and wherein
the cell identity change indication indicates whether the target cell identity is the same as the source cell identity.

9. The UE of claim 8, wherein:
the mobility scenario indication is an explicit parameter or a target node identity; and
the cell identity change indication is an explicit parameter or the target cell identity.

10. The UE of claim 8, wherein the configuration includes the mobility scenario indication, and if the UE performs connection reestablishment to the target cell, then the at least one processor is configured to cause the UE to:
calculate a timing advance (TA) for the target cell if the mobility scenario indication indicates that the HO or the CHO is inter-node; or
use a current TA of the source cell in the target cell if the mobility scenario indication indicates that the HO or the CHO is intra-node.

11. The UE of claim 8, wherein the configuration includes the cell identity change indication, and after the UE performs the HO or the CHO to the target cell, the at least one processor is configured to cause the UE to:
omit random access (RA) and initiate connection reestablishment in the target cell using uplink resources configured in the source cell if the cell identity change indication indicates that the target cell identity is the same as the source cell identity; or
initiate the RA or connection reestablishment in the target cell if the cell identity change indication indicates that the target cell identity is different from the source cell identity.

12. The UE of claim 3, wherein the configuration is associated with the target cell, and the UE receives a HO command to the target cell or a condition for the CHO to the target cell is met, if part of the configuration is received, then the HO or the CHO is performed if at least one of:
the mobility scenario indication, source cell ephemeris, and common TA of the source cell are received, wherein the mobility scenario indication indicates that the HO or the CHO is intra-node;
the mobility scenario indication, target cell ephemeris, and common TA of the target cell are received, wherein the mobility scenario indication indicates that the HO or the CHO is inter-node;
the cell identity change indication and configured uplink resource for connection reestablishment are received, wherein the cell identity change indication indicates that the target cell identity is the same as the source cell identity;
the cell identity change indication, and at least one of a configured time for RA initiation or a configured preamble set are received, wherein the cell identity change indication indicates that the target cell identity is different from the source cell identity; or
the cell identity change indication and configured uplink one or more resources for RA or connection reestablishment are received, wherein the cell identity change indication indicates that the target cell identity is different from the source cell identity.

13. The UE of claim 1, wherein the configuration includes at least one validity duration associated with at least one other content within the configuration, the at least one processor is configured to cause the UE to:
start at least one timer for the at least one other content; and
re-acquire the configuration or the at least one other content within the configuration before or after expiration of the at least one timer.

14. A base station (BS) for wireless communication, comprising:
at least one memory; and
at least one processor coupled with the at least one memory and configured to cause the BS to:
generate a configuration associated with mobility management of a non-terrestrial network (NTN) to switch a user equipment (UE) from a source cell to a target cell; and
broadcast the configuration associated with the mobility management.

15. The BS of claim 14, wherein the configuration associated with the mobility management includes at least one of:
a mobility scenario indication indicating an inter-node mobility; or
a cell identity change indication indicating whether a target cell identity matches a source cell identity or whether a target cell configuration matches a source cell configuration.

16. A method performed by a base station (BS), the method comprising:
generating a configuration associated with mobility management of a non-terrestrial network (NTN) to switch a user equipment (UE) from a source cell to a target cell; and
broadcast the configuration associated with the mobility management.

17. A method performed by a user equipment (UE), the method comprising:
receiving, from a BS, a configuration associated with mobility management of a non-terrestrial network (NTN) via broadcast signaling; and
apply the configuration associated with the mobility management to switch the UE from a source cell to a target cell.

18. The method of claim 17, wherein the configuration associated with the mobility management includes at least one of:
a mobility scenario indication indicating an inter-node mobility; or
a cell identity change indication indicating whether a target cell identity matches a source cell identity or whether a target cell configuration matches a source cell configuration.

19. The method of claim 17, wherein the configuration is associated with at least one of the source cell or the target cell.

20. The method of claim 17, further comprising causing the UE to apply the configuration if the configuration is associated with the source cell.
